(19) United States
(12) Patent Application Publication
(10) Pub. No.: US 2024/0013569 A1
(43) Pub. Date: Jan. 11, 2024

(54) SYSTEM FOR ACQUIRING IMAGES

(71) Applicant: ISORG, Limoges CEDEX 3 (FR)

(72) Inventors: Benjamin BOUTHINON, GRENOBLE (FR); Delphine DESCLOUX, GRENOBLE (FR); Jérôme MICHALLON, GRENOBLE (FR)

(21) Appl. No.: 18/021,536

(22) PCT Filed: Aug. 12, 2021
(86) PCT No.: PCT/EP2021/072465

§ 371 Date: Feb. 15, 2023

(30) Foreign Application Priority Data
Aug. 17, 2020 (FR) FR2008537

(51) Int. Cl. G06V 40/13; G06V 40/12; H10K 39/32

(52) U.S. Cl. CPC G06V 40/1318; G06V 40/1394; H10K 39/32; G02B 6/4203

(57) ABSTRACT

An image acquisition system includes a single organic image sensor, a waveguide layer covering the image sensor, and an image processing unit adapted to extract information relative to fingerprints and to veins of a hand imaged by the sensor. The waveguide layer is illuminated in a plane by a first source adapted to emit a first radiation having at least one wavelength in a range from 400 nm to 600 nm, and a second source adapted to emit a second radiation having its wavelength(s) in a range from 600 nm to 1,100 nm.

### RELATED APPLICATIONS

The present application claims the priority benefit of French patent application number 2008532 filed on Aug. 17, 2020 and entitled “systeme d'acquisition d'images”, the content of which is incorporated herein by reference as authorized by law.

### FIELD

The present disclosure generally concerns image acquisition systems and, more particularly, biometric image acquisition systems.

### BACKGROUND

Biometric acquisition systems, and more particularly fingerprint acquisition systems, are used in many fields in order to, for example, secure appliances, secure buildings, control accesses, or control the identity of individuals.

While data, information, accesses protected by fingerprint sensors multiply, fingerprint acquisition systems are the target of significant fraud.

The most current types of fraud are photocopies of fingers or of fingerprints or the reconstitution of fingers or of fingerprints in silicone, in latex, etc.

### SUMMARY

There is a need to improve and secure fingerprint acquisition systems.

An embodiment overcomes all or part of the disadvantages of known systems.

An embodiment provides an image acquisition system comprising:
a single organic image sensor;
a waveguide layer covering the image sensor and illuminated in the plane by:
   a first source adapted to emitting a first radiation having at least one wavelength in the range from 400 nm to 600 nm, and
   a second source capable of emitting a second radiation having its wavelength(s) in the range from 600 nm to 1,100 nm; and
an image processing unit adapted to extracting information relative to fingerprints and to the veins of a hand imaged by the sensor.

According to an embodiment, the first source and the second source face each other.

According to an embodiment, the first source and the second source are positioned:
so that the first radiation and the second radiation are perpendicular to each other; or
on a same side of the waveguide layer, one behind the other or one next to the other.

According to an embodiment:
the first radiation only comprises wavelengths in the range from 470 nm to 600 nm; and
the second radiation only comprises wavelengths in the range from 600 nm to 940 nm.

According to an embodiment:
the first light source is formed of one or a plurality of light-emitting diodes; and
the second light source is formed of one or a plurality of light-emitting diodes.

According to an embodiment, the waveguide layer comprises:
a first array of microstructures adapted to deviating the waves of the first radiation out of the waveguide layer on the side of the waveguide layer opposite to the image sensor; and
a second array of microstructures adapted to deviating the waves of the second radiation out of the waveguide layer on the side of the waveguide layer opposite to the image sensor.

According to an embodiment:
the first array of microstructures extends all along the length of the waveguide layer; and
the second array of microstructures extends all along the length of the waveguide layer.

According to an embodiment:
the second array of microstructures extends from the second light source over a first distance in the waveguide layer; and
the first array of microstructures extends from the first light source over a second distance in the waveguide layer.

According to an embodiment:
the first distance and the second distance are equal; or
the first distance and the second distance are different.

According to an embodiment, the information relative to the fingerprints is obtained from at least one image acquired by the image sensor with the second radiation.

According to an embodiment, the information relative to the veins is obtained from at least one image acquired by the image sensor with the first radiation.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 shows, in a partial simplified cross-section view, an example of an image acquisition system;

FIG. 2 shows, in a partial simplified top view, the image acquisition system illustrated in FIG. 1;

FIG. 3 shows, in partial simplified cross-section and top views, an embodiment of a portion of the image acquisition system illustrated in FIG. 1;

FIG. 4 shows, in a partial simplified cross-section view, an embodiment of another portion of the image acquisition system illustrated in FIG. 1;

FIG. 5 shows, in two top partial simplified top views, two embodiments of a color filter;

FIG. 6 shows, in a partial simplified cross-section view, another example of an image acquisition system;

FIG. 7 shows, in a partial simplified top view, an embodiment of the system illustrated in FIG. 6;

FIG. 8 shows, in a partial simplified top view, another embodiment of the system illustrated in FIG. 6;

FIG. 9 shows, in a block diagram, an example of implementation of an image acquisition method; and

FIG. 10 shows, in a partial simplified cross-section view, a structure comprising a polarizer.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the forming of the image acquisition system and of its components has only been briefly detailed, the described embodiments and implementation modes being compatible with usual embodiments of a cell phone and of these other elements.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless otherwise specified, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

Unless specified otherwise, the expressions “all the elements”, “each element”, signify between 95% and 100% of the elements.

Unless specified otherwise, the expression “it only comprises the elements” signifies that it comprises, by at least 90%, the elements, preferably that it comprises, by at least 95%, the elements.

In the following description, unless specified otherwise, a layer or a film is called opaque to a radiation when the transmittance of the radiation through the layer or the film is smaller than 10%. In the rest of the disclosure, a layer or a film is called transparent to a radiation when the transmittance of the radiation through the layer or the film is greater than 10%, preferably greater than 50%. According to an embodiment, for a same optical system, all the elements of the optical system which are opaque to a radiation have a transmittance which is smaller than half, preferably smaller than one fifth, more preferably smaller than one tenth, of the lowest transmittance of the elements of the optical system transparent to said radiation. In the rest of the disclosure, the expression “useful radiation” designates the electromagnetic radiation crossing the optical system in operation.

In the following description, the expression “micrometer-range optical element” designates an optical element formed on a surface of a support having its maximum dimension, measured parallel to said surface, greater than 1 μm and smaller than 1 mm.

Embodiments of optical systems will now be described for optical systems comprising an array of micrometer-range optical elements in the case where each micrometer-range optical element corresponds to a micrometer-range lens, or microlens, formed of two diopters. It should however be clear that these embodiments may also be implemented with other types of micrometer-range optical elements, where each micrometer-range optical element may for example correspond to a micrometer-range Fresnel lens, to a micrometer-range index gradient lens, or to a micrometer-range diffraction array.

In the following description, visible light designates an electromagnetic radiation having a wavelength in the range from 400 nm to 700 nm and, in this range, red light designates an electromagnetic radiation having a wavelength in the range from 600 nm to 700 nm. Infrared radiation designates an electromagnetic radiation having a wavelength in the range from 700 nm to 1 mm. In infrared radiation, one can in particular distinguish near infrared radiation having a wavelength in the range from 700 nm to 1.1 μm.

For the needs of the present description, the refraction index of a medium is defined as being the refraction index of the material forming the medium for the wavelength range of the radiation captured by the image sensor. The refraction index is considered as substantially constant over the wavelength range of the useful radiation, for example, equal to the average of the refraction index over the wavelength range of the radiation captured by the image sensor.

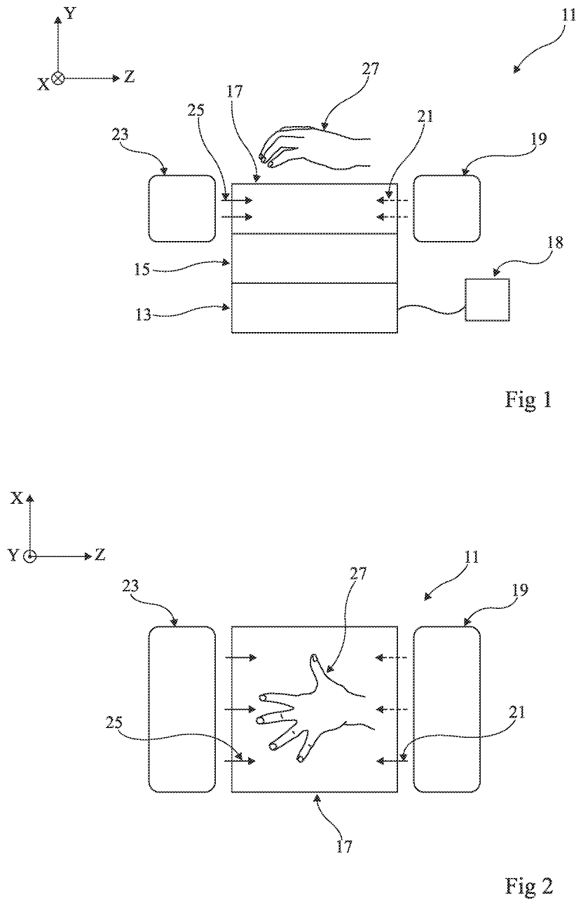

FIG. 1 shows, in a partial simplified cross-section view, an example of an image acquisition system.

FIG. 2 shows, in a partial simplified top view, the image acquisition system illustrated in FIG. 1.

The system comprises a device 11 comprising, from bottom to top in the orientation of the drawing:
a single organic image sensor 13; and
a layer 17, called waveguide, covering the upper surface of image sensor 13.

Device 11 further comprises, preferably, an optical filter 15, for example, an angular filter, between image sensor 13 and waveguide layer 17.

In the present description, the embodiments of FIGS. 1 to 8 are shown in space according to a direct orthogonal reference frame XYZ, axis Y of reference frame XYZ being orthogonal to the upper surface of sensor 13.

Device 11 is coupled to a processing unit 18 comprising, preferably, means for processing the signals delivered by device 11, not shown in FIG. 1. Processing unit 18 for example comprises a microprocessor. Device 11 and processing unit 18 are, for example, integrated in a same circuit.

Device 11 comprises a first light source 19 adapted to emitting a first radiation 21 and a second light source 23 adapted to emitting a second radiation 25. Sources 19 and 23 face each other. Sources 19 and 23 are for example laterally coupled to layer 17 and are not vertically in line, along direction Y, with the stack of sensor 13, of angular filter 15, and of layer 17.

According to an embodiment illustrated in FIGS. 1 and 2, device 11 captures the image response of an object 27, partially shown, preferably a hand. Image processing unit 18 is adapted to extracting information relative to fingerprints and to a network of veins of the hand 27 imaged by sensor 13.

Radiation 21 corresponds to a light radiation in red and/or in infrared, that is, to a radiation having the wavelength(s) forming it in the range from 600 nm to 1,700 nm. More preferably, radiation 21 corresponds to a light radiation having all the wavelengths forming it in the range from 600 nm to 1,100 nm, and more preferably still, in the range from 630 nm to 940 nm.

Radiation 25 corresponds to a light radiation in the visible range, that is, to a radiation having at least one of its wavelengths in the range from 400 nm to 800 nm. For example, radiation 25 corresponds to a light radiation having at least one wavelength in the range from 400 nm to 600 nm. More preferably, radiation 25 corresponds to a radiation having all the wavelengths forming it in the range from 400 nm to 600 nm. More preferably still, radiation 25 corresponds to a radiation having all the wavelengths forming it in the range from 470 nm to 600 nm. For example, radiation 25 corresponds to a radiation having its wavelengths approximately equal to 530 nm (green) or 500 nm (cyan).

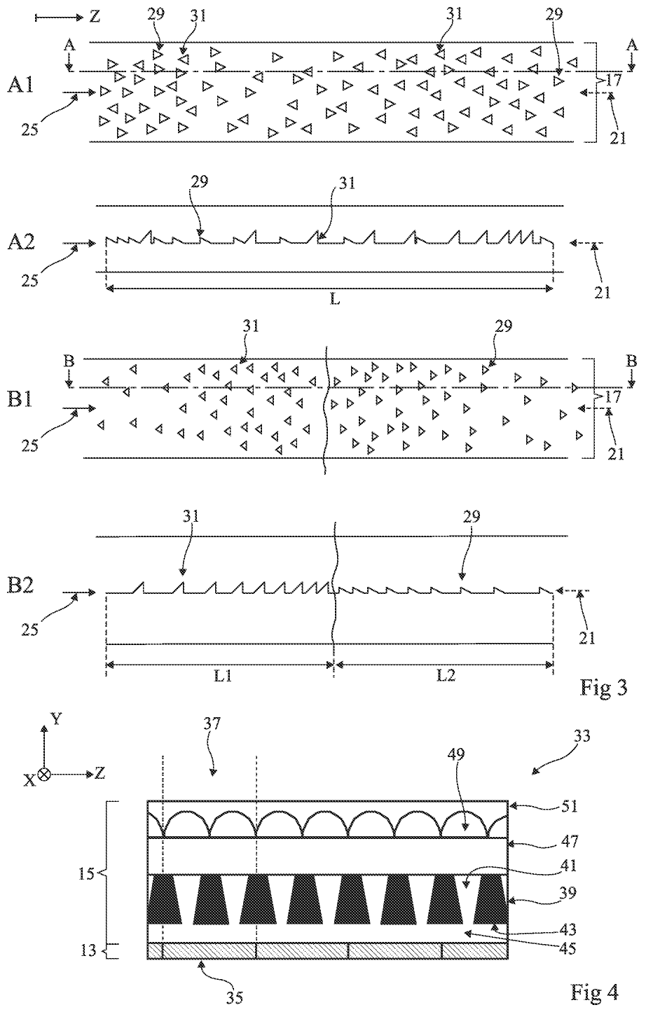

The structure of layer 17 is described later on in relation with FIG. 3 and angular filter 15 and sensor 13 are described later on in relation with FIG. 4.

According to an embodiment, sources 19 and 23 are positioned on the periphery of layer 17. For example, source 19 is located on the right-hand side of layer 17, in the orientation of FIGS. 1 and 2, and source 23 is located on the left-hand side of layer 17, in the orientation of FIGS. 1 and 2.

According to a variant, not shown, sources 19 and 23 are located indifferently with respect to each other. The two sources 19 and 23 are positioned, for example, on the same side of layer 17, one behind the other, one next to the other, or so that radiations 21 and 25 are orthogonal.

According to an embodiment, sources 19 and 23 are turned on one after the other to successively image hand 27 with the first radiation 21 only, and then hand 27 with the second radiation 25 only, or the other way around.

According to an embodiment, sources 19 and 23 are simultaneously turned on.

According to an embodiment, source 19 is formed of one or a plurality of light-emitting diodes (LED). Preferably, source 19 is formed of a plurality of LEDs organized in “arrays” along layer 17.

According to an embodiment, source 23 is formed of one or a plurality of light-emitting diodes. Preferably, source 23 is formed of a plurality of LEDs organized in “arrays” along layer 17.

FIG. 3 shows, in four partial simplified views, a portion of the image acquisition system illustrated in FIG. 1.

More particularly, FIG. 3 illustrates two embodiments of waveguide layer 17 of a length L.

FIG. 3 illustrates a first embodiment of layer 17 with a top view A1 and a cross-section view A2, view A2 being a view along the cross-section plane AA of view A1.

FIG. 3 illustrates a second embodiment of layer 17 in a top view B1 and a cross-section view B2, view B2 being a view along the cross-section plane BB of view B1.

Layer 17, called waveguide layer, comprises a structure of two or three mediums having different refraction indexes.

A waveguide layer is structurally adapted to allowing the confinement and the propagation of electromagnetic waves. The mediums are for example arranged in the form of a stack of three sub-layers, a central layer sandwiched between an upper sheath and a lower sheath, the refraction indexes of the materials forming the sheaths being smaller than the refraction index of the material forming the central layer, the lower sheath being located on the side of angular filter 15. Preferably, microstructures are formed, by nanoimprint between the central layer and the lower sheath. The microstructures preferably have the shape of isosceles prisms having their top, that is, peak, angle equal to 45°, of isosceles rectangular prisms, or of teeth having their tips directed towards the object to be imaged. The microstructures may have shapes of half-spheres, of cones, of pyramids, or tetrahedrons, etc. Each microstructure may comprise a surface, for example, planar, slightly inclined in the wave propagation direction so that the propagated wave is deviated and follows the geometry of the microstructures. The inclination of the surface of the microstructure with respect to the lower surface of the central layer is for example in the range from 5° to 80°. The inclination is preferably in the order of 45°. For example, the microstructures are not uniformly distributed along the wave path. The microstructures are preferably closer and closer towards the output of the waveguide. The microstructure density is preferably higher and higher as the distance to the source of the radiation deviated by these microstructures increases. The microstructures are preferably filled with a material of lower optical index that the central layer or with air. The central layer is for example made of poly(methyl methacrylate) (PMMA), of polycarbonate (PC), of cyclic olefin polymer (COP), or of poly(ethylene terephthalate) (PET). The sheaths are for example made of epoxy or acrylate resins having a refraction index smaller than the refraction index forming the central layer.

A first array of microstructures 29 is for example adapted to guiding the first waves of the first radiation 21 emitted by the first source 19 (FIGS. 1 and 2). The first array then comprises microstructures 29 inclined in the direction of the waves emitted by the first source 19.

A second array of microstructures 31 is for example adapted to guiding the second waves of the second radiation emitted by second source 23 (FIGS. 1 and 2). The second array then comprises microstructures 31 inclined in the direction of the waves emitted by second source 23.

According to an embodiment, layer 17 has a thickness in the range from 200 μm to 600 μm, preferably in the range from 300 μm to 500 μm. According to an embodiment, the central layer has a thickness in the range from 1 μm to 40 μm, preferably in the range from 1 μm to 20 μm. The microstructures for example have a thickness in the range from 1 μm to 15 μm, preferably in the range from 2 μm to 10 μm.

According to the embodiment illustrated in FIG. 3 (view A), each array of microstructures 31 extends from the lateral edge of the layer 17, adjacent to source 23, along a length L. Each array of microstructures 31 for example extends, at the farthest, to the lateral edge, opposite to source 23, of layer 17. Length L substantially corresponds to the length of layer 17. Length L may be in the range from 10 mm to 250 mm. Further, each array of microstructures 29 extends from the lateral edge of layer 17, adjacent to source 19, along the same length L. Each array of microstructures 29 extends, for example, at farthest, to the lateral edge, opposite to source 19, of layer 17.

According to the embodiment illustrated in views B1 and B2 of the figure, each array of microstructures 31 extends from the lateral edge of layer 17, adjacent to source 23, along a length L1, and each array of microstructures 29 extends from the lateral edge of layer 17, adjacent to source 19, along a length L2.

Length L is preferably greater than or equal to the addition of lengths L1 and L2. Lengths L1 and L2 may be different or equal. Length L2 is for example equal to three times length L1.

According to an embodiment, not shown, a single array of microstructures is both adapted to guiding the second waves of the second radiation 25 emitted by the second source 23 and adapted to guiding the first waves of the first radiation 21 emitted by the first source 19.

According to an embodiment, not shown in FIG. 3, layer 17 is covered in the stack of image acquisition device 11 with a protection layer. The protection layer particularly enables to avoid for layer 17 to be scratched by the user of device 11.

FIG. 4 shows, in a partial simplified cross-section view, another portion of the image acquisition system illustrated in FIG. 1.

More particularly, FIG. 4 illustrates a structure 33 comprising the angular filter 15 and the sensor 13 of device 11.

Sensor 13 comprises photodetectors 35, preferably arranged in an array. Photodetectors 35 preferably all have the same structure and the same properties/features. In other words, all the photodetectors are substantially identical, to within manufacturing differences. Sensor 13 is preferably adapted to capturing radiations 21 and 25.

Photodiodes 35 are for example organic photodiodes (OPD) integrated on a CMOS (Complementary Metal Oxide Semiconductor) substrate or a thin film transistor substrate (TFT). The substrate is for example made of silicon, preferably, of single-crystal silicon. The channel, source, and drain regions of the TFT transistors are for example made of amorphous silicon (a-Si), of indium gallium zinc oxide (IGZO), or of low temperature polysilicon (LIPS).

The photodiodes 35 of image sensor 13 comprise, for example, a mixture of organic semiconductor polymers, for example poly(3-hexylthiophene) or poly(3-hexylthiophene-2,5-diyl), known as P3HT, mixed with [6,6]-phenyl-C₆₁-butyric acid methyl ester (N-type semiconductor), known as PCBM.

The photodiodes 35 of image sensor 13 for example comprise small molecules, that is, molecules having molar masses smaller than 500 g/mol, preferably, smaller than 200 g/mol.

Photodiodes 35 may be non-organic photodiodes, for example, formed based on amorphous silicon or crystalline silicon. As an example, photodiodes 35 are formed of quantum dots.

Angular filter 15, illustrated in FIG. 4, comprises from bottom to top in the orientation of the drawing:
a first layer 39 comprising openings 41, or holes, and walls 43 opaque to radiations 21 and 25. Openings 41 are, for example, filled with a material forming, on the lower surface of layer 39, a layer 45;
a substrate or support 47, resting on the upper surface of layer 39; and
an array of micrometer-range lenses 49, located on the upper surface of substrate 47, the planar surface of lenses 49 and the upper surface of substrate 47 facing each other. The array of lenses 49 is topped with a planarizing layer 51.

Substrate 47 may be made of a transparent polymer which does not absorb at least the considered wavelengths, here in the visible and infrared range. The polymer may in particular be made of polyethylene terephthalate PET, poly(methyl methacrylate) PMMA, cyclic olefin polymer (COP), a polyimide (PI), polycarbonate (PC). The thickness of substrate 47 may for example vary between 1 μm and 100 μm, preferably between 10 μm and 100 μm. The substrate may correspond to a colored filter, to a polarizer, to a half-wave plate or to a quarter-wave plate.

Lenses 49 may be made of silica, of PMMA, of positive resist, of PET, of poly(ethylene naphthalate) PEN, of COP, of polymethylsiloxane (PDMS)/silicone, of epoxy resin, or of acrylate resin. Lenses 49 may be formed by flowing of resist blocks. Lenses 49 may further be formed by molding on a layer of PET, PEN, COP, PDMS/silicone, of epoxy resin, or of acrylate resin. Lenses 49 are converging lenses, each having a focal distance f in the range from 1 μm to 100 μm, preferably from 1 μm to 70 μm. According to an embodiment, all lenses 49 are substantially identical.

According to the present embodiment, lenses 49 and substrate 47 are preferably made of materials that are transparent or partially transparent, that is, transparent in a portion of the spectrum considered for the targeted field, for example, imaging, over the wavelength range corresponding to the wavelengths used during the exposure.

According to an embodiment, layer 51 is a layer which follows the shape of lenses 49. Layer 51 may be obtained from an optically clear adhesive (OCA), particularly a liquid optically clear adhesive, or a material with a low refraction index, or an epoxy/acrylate glue, or a film of a gas or of a gaseous mixture, for example, air.

Openings 41 are for example filled with air, with partial vacuum, or with a material at least partially transparent in the visible and infrared ranges.

The described embodiments take as an example the case of an angular filter 15 forming an angular filter. However, these embodiments may apply to other types of optical filters.

Angular filter 15 is adapted to filtering the incident radiation according to the incidence of the radiation with respect to the optical axes of lenses 49.

Angular filter 15, more particularly, adapted so that each photodetector 35 of image sensor 13 only receives the rays having their respective incidences with respect to the respective optical axes of the lenses 49 associated with this photodetector 35 smaller than a maximum incidence smaller than 45° preferably smaller than 30°, more preferably smaller than 10°, more preferably still smaller than 4°. Angular filter 15 is capable blocking the rays of the incident radiation having respective incidences relative to the optical axes of the lenses 49 of angular filter 15 greater than the maximum incidence.

Each opening 41 is preferably associated with a single lens 49. The optical axes of lenses 49 are preferably centered with the centers of the openings 41 of layer 39. The diameter of lenses 49 is preferably greater than the maximum size of the section (perpendicular to the optical axis of lenses 49) of openings 41.

Each photodetector 35 is preferably associated with at least four openings 41 (and four lenses 49). Preferably, each photodetector 35 is associated with exactly four openings 41.

Structure 33 is preferably divided into pixels 37. The term pixels is used all along the description to define a portion of image sensor 13 comprising a single photodetector 35. The denomination pixel may apply at the scale of image sensor 13, but also at the scale of structure 33. At the scale of structure 33, a pixel is the entire stack, forming structure 33, vertically in line with the pixel 37 of sensor 13. All along this description, the term pixel 37, unless specified otherwise, refers to a pixel at the scale of structure 33.

In the example of FIG. 4, a pixel 37 corresponds to each portion of structure 33 comprising, among others, a photodetector 35 topped with four openings 41, themselves topped with four lenses 49. Each pixel 37 is preferably of substantially square shape along a direction perpendicular to the upper surface of image sensor 13. For example, the surface area of each pixel corresponds to a square having the dimension of one of its sides in the range from 32 μm to 100 μm, preferably in the range from 50.8 μm to 80 μm.

Each pixel 37 may be associated with a number of lenses 49 different from four and this, according to the diameter of lenses 49 and to the dimensions of pixels 37.

In the example of FIG. 4, a pixel 37 comprises a photodetector 35 topped with four openings 41. In practice, the angular filter 15 comprising openings 41 may be laminated on image sensor 13 with no prior alignment of angular filter 15 on image sensor 13. Some lenses 49 and openings 41 may then be located in the orientation of the stack, that is, along direction Y, astride two photodetectors 35.

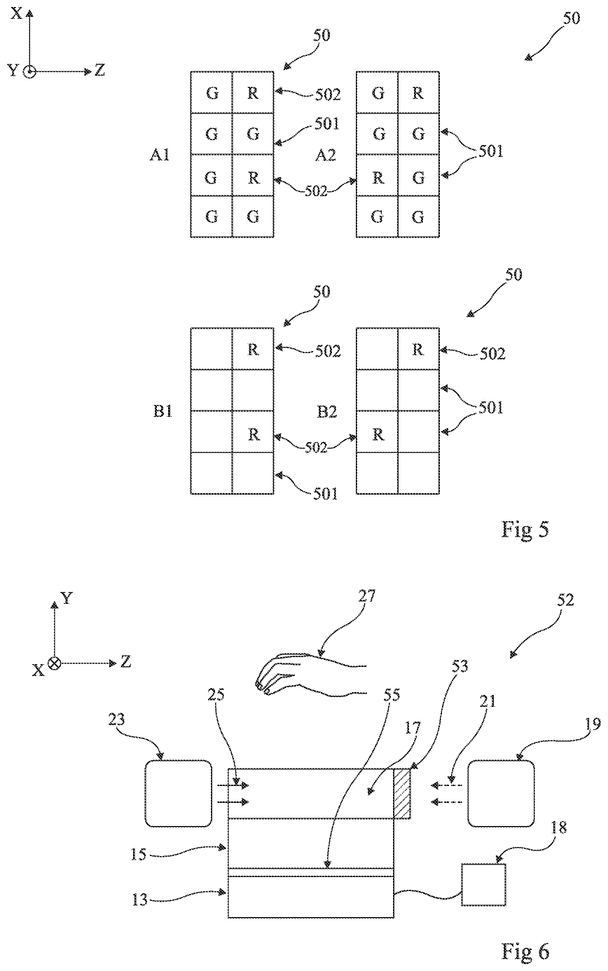

FIG. 5 shows, in two partial simplified top views, two embodiments of a color filter 50.

More particularly, FIG. 5 illustrates a color filter preferably intended to be positioned on the upper surface of angular filter 15 (FIG. 4).

Color filter 50 is divided in two portions.

One or first portions 501 of color filter 50 are adapted to giving way, according to an embodiment illustrated in views B1 and B2, to all the visible and infrared radiation, preferably only the visible radiation, more preferably still only a portion of the visible radiation, particularly only the green radiation. The first portions 501 (G) are adapted to giving way, according to an embodiment illustrated in views A1 and A2, to only at least one wavelength in the range from 400 nm to 600 nm, more preferably in the range from 470 nm to 600 nm. According to a specific embodiment, the first portions 501 are adapted to only giving way to the wavelength equal to 530 nm or to 500 nm.

One or second portions 502 (R) of color filter 50 are adapted to blocking all the wavelengths outside of the range from 600 nm to 1,100 nm, preferably outside of the range from 630 nm to 940 nm.

According to the embodiment illustrated in FIG. 5, each second portion 502 of color filter 50 is formed at the surface of angular filter 15 so that a pixel 37 is covered with each second portion 502.

According to the embodiment illustrated in FIG. 5, each second portion 502 of color filter 50 has a square shape in the view of FIG. 5. For example, the surface of each second portion 502 of color filter 50 is equal to the size of a pixel, that is, a square of approximately 50.8 μm by 50.8 μm.

As an example, the repetition pitch of the second portions 502 of color filter 50 is in the range from two pixels 37 to twenty pixels 37. Preferably, the repetition pitch of the second portions 502 is approximately ten pixels 37 along axis Z and ten pixels 37 along axis X. In other words, nine pixels separate two consecutive pixels along axis Z (or X) covered with second portions 502. Still in other words, in a square assembly of one hundred pixels (that is, a square of ten pixels along axis Z and ten pixels along axis X), a single pixel is covered with a second portion 502.

According to the embodiment illustrated in view A1 and B1, the second portions 502 are arranged so that, for example within an assembly of eight pixels (two columns of pixels and four rows of pixels), two second portions 502 are formed at the surface of angular filter 15 to cover two pixels of a same column. According to the embodiment illustrated in view A2 and B2, the second portions 502 are arranged so that, for example within an assembly of eight pixels (two pixel columns and four pixel rows), two second portions 502 are formed at the surface of angular filter 15 to cover two pixels of two different columns. In these two embodiments, the repetition pitch of the second portions 502 is two pixels, however they are easily adaptable for a repetition pitch of the second portions greater than two pixels.

According to an embodiment, the material forming second portion 502 is a material only transparent to wavelengths in the range from 600 nm to 1,100 nm (near infrared filter), preferably in the range from 630 nm to 940 nm, for example, an organic resin comprising a dye adapted to filtering all the wavelengths which are not within the above-mentioned band. The second portions 502 may for example be formed based on interference filters.

According to the embodiment illustrated in FIG. 5, the other pixels 37 are covered with the first portion 501 of color filter 50. Preferably, first portion 501 is jointing between two neighboring pixels 37, that is, first portion 501 is not pixelated and it is simultaneously formed over all the considered pixels of image sensor 13.

According to an embodiment, the material forming first portion 501 is air or a partial vacuum.

According to an embodiment, the material forming first portion 501 is a material only transparent to wavelengths in the range from 400 nm to 600 nm (visible filter), preferably in the range from 470 nm to 600 nm, for example, a resin comprising the dye known under trade name “Orgalon Green 520” or a resin from the commercial series “COLOR MOSAIC” manufactured by Fujifilm. First portion 501 may for example be formed based on interference filters.

According to an embodiment, the material forming first portion 501 is made of a material only transparent at 500 nm (cyan filter) or only transparent at 530 nm (green filter), for example, a resin comprising the dye known under trade name “PC GREEN 123P” or a resin from commercial series “COLOR MOSAIC” manufactured by Fujifilm. First portion 501 may for example be formed based on interference filters.

FIG. 6 shows, in a partial simplified cross-section view, another example of an image acquisition device.

More particularly, FIG. 6 illustrates a device 52 similar to the device 11 illustrated in FIG. 1, with the difference that it comprises two polarizers.

Device 52 comprises:
at least one first polarizer 53; and
a second polarizer 55.

Each first polarizer 53 is located in device 52 so that the radiation 21 originating from first source 19 preferably crosses first polarizer 53 before reaching optical sensor 13. More particularly, radiation 21 crosses first polarizer 53 and is then reflected by hand 27 and crosses second polarizer 55 before reaching optical sensor 13. First polarizer 53 thus laterally covers (along axis (Y)) source 19.

According to an embodiment, the number of first polarizers 53 is similar to the number of first sources 19 so that each first source 19 is associated with a single first polarizer 53 and that each first polarizer 53 is associated with a single first source 19. Each first polarizer 53 thus has a surface area (in plane XY) equal to or greater than the surface area of the source 19 with which it is associated.

As a variant, the number of first polarizers 53 is smaller than the number of first sources 19, the surface area of each first polarizer then being greater than the surface area of each first source 19. In other words, each first polarizer is associated with and laterally covers more than one first source 19. For example, device 52 comprises a single polarizer which laterally covers all sources 19.

According to the embodiment illustrated in FIG. 6, the second polarizer 55 is located between angular filter 15 and image sensor 13 or between layer 17 and angular filter 15.

According to the embodiment illustrated in FIG. 6, the first polarizer(s) 53 and the second polarizer 55 are rectilinear, or in other words linear.

According to the embodiment illustrated in FIG. 6, the first polarizer(s) 53 polarize in a first direction which will also be called horizontal direction hereafter.

According to the embodiment illustrated in FIG. 6, the second polarizer 55 is formed of:
one or a plurality of first portions which directly polarize in a second direction, perpendicular to the first direction, which will also be called vertical direction hereafter; and
one or a plurality of second portions which polarize along the horizontal direction.

According to an embodiment, light source 19 emits a radiation 21 of small divergence, that is, the rays of radiation 21 are within a radiation cone having an angle smaller than 15°, preferably smaller than 5°.

As a variant, light source 19 is coupled to an angular filter (not shown), located between source 19 and the first polarizer 53 or between the first polarizer 53 and layer 17. The above-mentioned angular filter is adapted to blocking all the rays emitted by source 19 having an incidence, measured with respect to axis Z, greater than 15°, preferably greater than 5°.

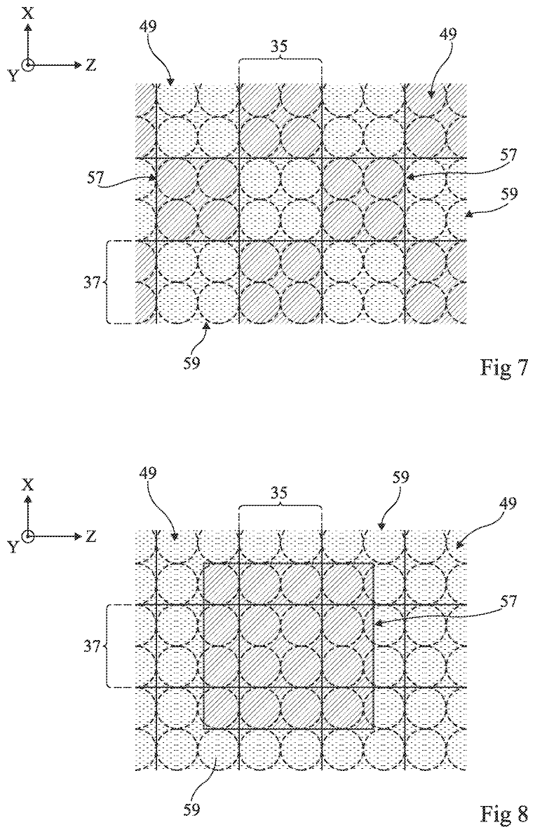

The arrangement of the first and second portions of second polarizer 55 is illustrated in FIGS. 7 and 8.

FIG. 7 shows, in a partial simplified top view, an embodiment of the device illustrated in FIG. 6.

More particularly, FIG. 7 illustrates an embodiment of the arrangement of the first portions 57 and second portions 59 of second polarizer 55.

According to the embodiment illustrated in FIG. 7, the first portions 57 and each second portion 59 of polarizer 55 are formed at the surface of layer 17 so that one pixel 37 out of two is covered with a first portion 57 and one pixel 37 out of two, different from the former ones, is covered with a second portion 59. For each square group of four pixels 37, two of pixels 37 are covered with first portions 57 and two of pixels 37, different from the previous pixels are, for example, covered with second portions 59.

According to the embodiment illustrated in FIG. 7, each first portion 57 and each second portion 59 of the second polarizer 55 has a substantially square shape in the view of FIG. 7. For example, the surface areas of each first portion 57 and each second portion 59 of the second polarizer 55 are equal to a square of approximately 50.8 μm by 50.8 μm.

According to an implementation mode, second polarizer is for example formed by successive depositions of the first portions 57 and of the second portions 59, at the surface of layer 17.

As a variant, for each square group of four pixels 37, only one pixel 37 is covered with a first portion 57, the three other pixels being covered with second portions 59.

As a variant, the repetition pitch of first portions 57 may be greater than two pixels. The repetition pitch of the first portions may be in the range from two pixels 37 to twenty pixels 37, preferably, in the range from five pixels 37 to fifteen pixels 37, and more preferably equal to approximately ten pixels 37.

FIG. 8 shows, in a partial simplified top, view another embodiment of the device illustrated in FIG. 6.

More particularly, FIG. 8 illustrates another embodiment of the arrangement of the first portions 57 and second portions 59 of second polarizer 55.

Preferably, the first portions 57 and second portions 59 of the second polarizer 55 are arbitrarily formed at the surface of sensor 13.

In FIG. 8, each first portion 57 of second polarizer has a surface area greater (in plane XY) than the surface area of each first portion 57 of the second polarizer 55 illustrated in FIG. 7.

According to the embodiment illustrated in FIG. 8, each first portion 57 of second polarizer 55 is formed on layer 17 with no prior alignment thereof with the underlying photodetectors 35 or lenses 49.

According to the embodiment illustrated in FIG. 8, each first portion 57 has a substantially square shape in the view of FIG. 8. Preferably, each first portion 57 has a surface area enabling to integrally cover, on the upper surface of layer 17, at least one pixel 37 (or a photodetector 35) and this, whatever its location on the upper surface of layer 17. Thus, the surface area of each first portion 57 is at least equal to the surface area of four pixels 37. Preferably, the surface area of each first portion 57 is in the range from the surface area of four pixels 37 to the surface area of six pixels 37. For example, the surface area of each first portion 57 is equal to the surface area of four pixels 37. The upper surface of layer 17, not covered with first portions 57, is covered with second portions 59. The relative positions between pixels 37 and the first and second portions 57, 59 being unknown, a calibration step may be provided to determine the positions of the pixels covered with the first portions 57, for example, by illuminating the image acquisition device with a radiation for example horizontally polarized so that only the pixels covered with the first portions will capture a radiation.

According to an implementation mode, second polarizer 55 is, for example, formed by successive depositions of the first portions 57 and of the second portions 59 at the surface of layer 17.

According to an embodiment, the repetition pitch of the first portions 57 is in the range from a distance corresponding to the dimension of three pixels to a distance corresponding to the dimension of twenty pixels. Preferably, the repetition pitch is substantially equal to a distance corresponding to the ten-pixel dimension. The distribution of the first portions 57 is aligned, that is, the repetition is performed in rows and in columns, or in shifted fashion, that is, the distribution is shifted by one or a plurality of pixels from one row to the next one or from one column to the next one. Similarly, the distribution of the second portions 59 is aligned, that is, the repetition is performed in rows and in columns, or in shifted fashion, that is, the distribution is shifted by one or a plurality of pixels from one row to the next one or from one column to the next one

An advantage of the embodiments and of the implementation modes previously described in relation with FIGS. 6 to 8 is that they enable to simultaneously take an image under horizontally-polarized radiation 21 and then, after reflection on hand 27 horizontally (that is, an image under radiation 21 having crossed two aligned polarizers) and an image under horizontally-polarized radiation 21 and then, after reflection on hand 27, vertically (that is, an image under radiation 21 having crossed two crossed polarizers).

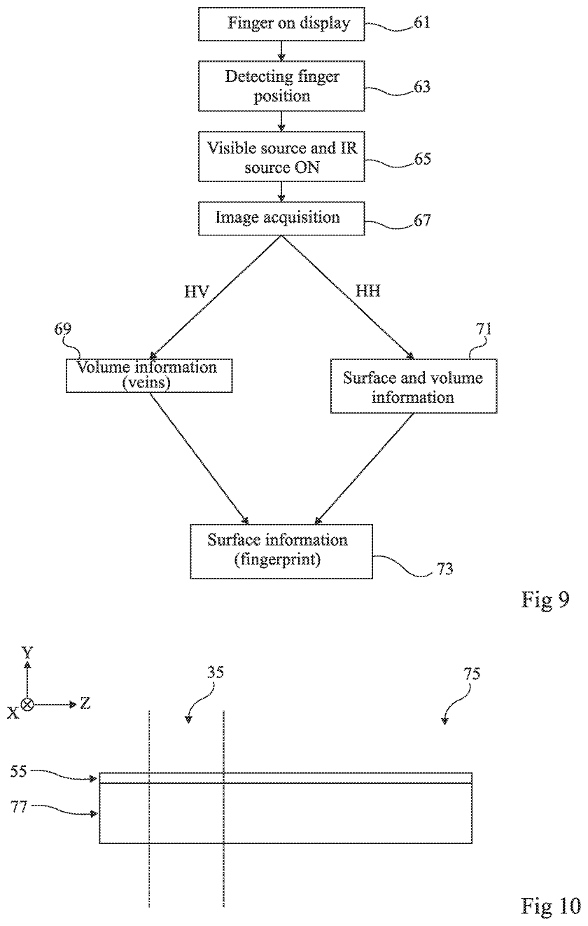

FIG. 9 shows, in a block diagram, an example of implementation of an image acquisition method.

More particularly, FIG. 9 illustrates a method enabling to acquire images and to process them in the case of a device comprising sources 19 and 23 (FIGS. 1 and 2).

This method breaks down in two flows. A first flow concerns the acquisition of images by image sensor 13. A second flow concerns the processing performed on the acquired images.

According to the implementation mode illustrated in FIG. 9, the first flow starts with a step 61 of placing of hand 27 on the upper surface of layer 17 (Finger on display). Step 61 is followed by a step 63 where the position of hand 27 is detected (Detecting finger position) and located on layer 17. The detection of the position of hand 27 may be performed by a detection element included in the image acquisition device or by an element internal to image sensor 13, for example, one of its electrodes.

The first flow comprises, in a subsequent step 65, the turning on of sources 19 and 23 (Visible source and IR source ON).

Step 65 is followed by a step 67 of acquisition of an image, of division of this image into two distinct images, according to whether the pixels are associated with a first portion 57, or with the second portion 58 of the second polarizer 55, and of storage of these images (Image acquisition).

The first image is the image which is associated with photodetectors 35 (FIG. 4) topped with a first portion 57 of second polarizer 55. Thus, before reaching photodetector 35, radiation 21 is polarized by first polarizer 53 in the horizontal direction (H) and then, after reflection on hand 27, is polarized by the first portion 57 of second polarizer 55 in the vertical direction (V), before reaching image sensor 13.

The second image is the image associated with photodetectors 35 (FIG. 4) topped with a second portion 59 of second polarizer 55. Thus, before reaching photodetector 35, radiation 21 is polarized by first polarizer 53 in the horizontal direction (H) and then, after reflection on hand 27, is polarized by the second portion 59 of second polarizer 55 in the horizontal direction (H), before reaching image sensor 13.

The second flow comprises two phases respectively dedicated to the separate processing of the two images and to the processing of the combination of the two images.

The first phase of the second flow comprises the processing of the first acquired image (output HV of block 67) to extract therefrom at a step 69 an image comprising volume information relative to hand 27 (Volume information (veins)). Volume information designates the information having required the penetration of light into the volume of the hand to be acquired. The information concerning the veins, for example, their number, their shape, and their arrangement within the hand, are, for example volume information.

The first phase of the second flow further comprises the processing of the second acquired image (output HH of block 67) to extract therefrom at a step 71 an image comprising surface and volume information relative to hand 27 (Surface and volume information).

The second phase of the second flow comprises a step 73 during which the information originating from the first image and the information originating from the second image are processed together to extract surface information only (Surface information (fingerprint)). This may comprise determining a third image corresponding to the difference, possibly weighted, between the second image and the first image. Surface information designates the information having required the reflection of light at the surface of the hand to be acquired. The information concerning fingerprints is, for example, surface information. It is for example an image of the grooves and of the ridges of the fingerprints.

FIG. 10 shows, in a partial simplified cross-section view, a structure comprising a polarizer.

More particularly, FIG. 10 illustrates an embodiment of a structure 75 where the second polarizer 55 has been formed at the surface of a support 77.

Preferably, the second polarizer 55 illustrated in FIG. 10 is identical to the second polarizer 55 illustrated in FIG. 6. The second polarizer 55 is however formed on support 77, conversely to FIG. 6 where polarizer 85 is formed on image sensor 13. This advantageously enables to form the second polarizer 55 separately from the other elements of image acquisition device 52.

Support 77 may be made of a transparent polymer which does not absorb at least the considered wavelengths, here in the visible and infrared range. This polymer may in particular be made of polyethylene terephthalate PET, of poly(methyl methacrylate) PMMA, of cyclic olefin polymer (COP), of polyimide (PI), or of polycarbonate (PC). Support 77 is preferably made of PET. The thickness of support 77 may vary from 1 μm to 100 μm, preferably from 10 μm to 50 μm. Support 77 may correspond to a colored filter, to a half-wave plate, or to a quarter-wave plate.

The arrangement of the first portions 57 and of the second portions 59 of the second polarizer 55 illustrated in FIG. 10 is similar to the arrangement of the portions 57 and 59 of the second polarizer 55 illustrated in FIGS. 7 and 8.

According to an embodiment, structure 75 is assembled in the image acquisition device 52 of FIG. 6, to replace second polarizer 55, between angular filter 15 and layer 17.

According to an embodiment, structure 75 is assembled in the image acquisition device 52 of FIG. 6 to replace the second polarizer 55, between angular filter 15 and image sensor 13.

As a variant, polarizer 55 is formed under substrate 77. During the transfer of structure 75, the lower surface of polarizer 55 is then in contact with the upper surface of image sensor 13 or in contact with the upper surface of angular filter 15 according to whether structure 75 is positioned between angular filter 15 and layer 17 or between angular filter 15 and image sensor 13.

An advantage of the described embodiments and implementation modes is that they enable to considerably decrease the possibilities of fraud on fingerprint sensors.

Still another advantage of the described embodiments and implementation modes is that they enable to decrease manufacturing costs since a single sensor is used to capture the visible radiation and the infrared radiation.

Various embodiments and variants have been described. Those skilled in the art will understand that certain features of these various embodiments and variants may be combined, and other variants will occur to those skilled in the art. In particular, the embodiments and implementation modes may be combined. The described embodiments are for example not limited to the examples of dimensions and of materials mentioned hereabove.

Finally, the practical implementation of the described embodiments and variations is within the abilities of those skilled in the art based on the functional indications given hereabove.

1. An image acquisition system comprising:
a single organic image sensor;
a waveguide layer covering the image sensor and illuminated in a plane by:
a first source adapted to for emitting a first radiation having at least one wavelength in a range from 400 nm to 600 nm, and
a second source adapted to for emitting a second radiation having its wavelength(s) in a range from 600 nm to 1,100 nm; and
an image processing unit adapted to for extracting information relative to fingerprints and to veins of a hand imaged by the sensor,
wherein the waveguide layer comprises:
a first array of microstructures adapted for deviating waves of the first radiation out of the waveguide layer on a side of the waveguide layer opposite to the image sensor; and
a second array of microstructures adapted for deviating waves of the second radiation out of the waveguide layer on the side of the waveguide layer opposite to the image sensor.

2. The system according to claim 1, wherein the first source and the second source face each other.

3. The system according to claim 1, wherein the first source and the second source are positioned:
so that the first and the second radiation are perpendicular to each other; or
on a same side of the waveguide layer, one behind the other or one next to the other.

4. The system according to claim 1, wherein:
the first radiation only comprises wavelengths in a range from 470 nm to 600 nm; and
the second radiation only comprises wavelengths in a range from 600 nm to 940 nm.

5. The system according to claim 1, wherein:
the first light source is formed of one or a plurality of light-emitting diodes; and
the second light source is formed of one or a plurality of light-emitting diodes.

6. The system according to claim 1, wherein:
the first array of microstructures extends all along a length of the waveguide layer; and
the second array of microstructures extends all along a length of the waveguide layer.

7. The system according to claim 1, wherein:
the second array of microstructures extends from the second light source over a first distance in the waveguide layer; and
the first array of microstructures extends from the first light source over a second distance in the waveguide layer.

8. The system according to claim 7, wherein:
the first distance and the second distance are equal; or
the first distance and the second distance are different.

9. The system according to claim 1, wherein the information relative to the fingerprints is obtained from at least one image acquired by the image sensor with the first radiation.

10. The system according to claim 1, wherein the information relative to the veins is obtained from at least one image acquired by the image sensor with the second radiation.
